(19) United States
(12) Patent Application Publication
(10) Pub. No.: US 2013/0275211 A1
(43) Pub. Date: Oct. 17, 2013

(54) SERVER AND METHOD FOR PROVIDING INFORMATION OF LOCAL PRODUCT

(71) Applicant: CHENG-HUANG LU, Shenzhen City (CN)

(72) Inventor: CHENG-HUANG LU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/488,673

(22) Filed: Jun. 5, 2012

(30) Foreign Application Priority Data
Apr. 11, 2012 (CN) 201210104454.4

(51) Int. Cl. G06Q 30/00; H04W 4/02; G06Q 30/02

(52) U.S. Cl. 705/14.49; 705/26.9; 705/26.61

(57) ABSTRACT

A computerized method provides information of local products using a server. Information of various products published by one or more product vendors is stored into a product database. When a user accesses the server using a client device, a location of the user is acquired and a geographical area where the user is located is determined. Products local to the determined geographical area are searched from the product database, and are displayed on a user interface for the user to select his/her favorite. When one of the searched products is selected, purchasing addresses of the selected product are searched from the product database and the nearest purchasing address to the user is determined. One or more routes from the user to the nearest purchasing address are calculated according to an electronic map, and are displayed on the user interface.

### BACKGROUND

1. Technical Field

Embodiments of the present disclosure relate to a server and a method for providing information of local products.

2. Description of Related Art

Many travelers or tourists like to purchase unique local products from where they are travelling to. However, it may be difficult for them to find the place to buy the unique local products while they are visiting an unfamiliar place.

### BRIEF DESCRIPTION OF THE DRAWINGS

FIG. 1 is a schematic diagram illustrating one embodiment of a server in communication with a plurality of client devices.

FIG. 2 is a schematic block diagram illustrating one embodiment of the server of FIG. 1.

FIG. 3 is a flowchart of one embodiment of a method for providing information of unique local products using the server of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

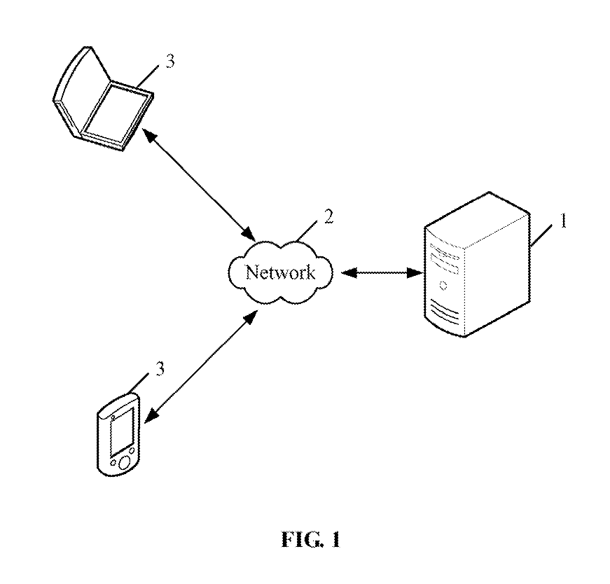

FIG. 1 illustrates one embodiment of a server 1 in communication with a plurality of client devices 3 through a network 2. In the embodiment, the server 1 provides information of various products to the client devices 3. A user can access the server 1 using one of the client devices 3 to obtain the information of the products. In one embodiment, the client devices 3 may be smart phones, personal digital assistants, mobile internet devices, portable computers, desktop computers, or other similar devices. The server 1 may be a web server, for example. The network 2 may be a wired network or a wireless network.

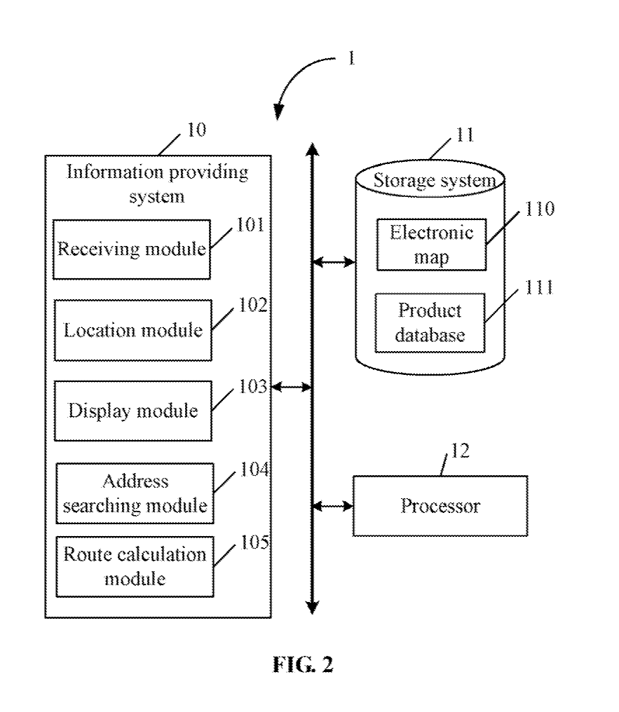

FIG. 2 is a schematic block diagram illustrating one embodiment of the server 1 of FIG. 1. In the embodiment, the server 1 includes an information providing system 10, a storage system 11, and a processor 12. The storage system 11 includes an electronic map 110 and a product database 111 for storing the product information. FIG. 2 is only one example of the server 1, and the server 1 can include more or fewer components than those shown in the embodiment, or have a different configuration of the components.

The information providing system 10 may include a plurality of programs in the form of one or more computerized instructions stored in the storage system 11 and executed by the processor 12 to perform operations of the server 1. In the embodiment, the information providing system 10 includes a receiving module 101, a location module 102, a display module 103, an address searching module 104, and a route calculation module 105. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 101 receives information of various products from one or more product vendors, and stores the received information into the product database 111. The received information includes, for example, names, prices and images of the products, and purchasing addresses of the products. The product vendors may use one of the client devices 3 to login into the server 1, and upload the information of the products to the product database 111 of the server 1. Additionally, the receiving module 101 can send an advertisement message relevant to the products to the client devices 3 through the network 2. The advertisement message may include, for example, popular products in the product database 111 and a way (i.e., a website address of the server 1) to access the server 1.

The location module 102 acquires a location of a user when the user accesses the server 1 using the client device 3, and determines a geographical area where the location of the user is located. In one embodiment, the geographical area may represent a particular city, such as, Guilin, Chengdu, and Beijing. For example, if the location of the user is “XX Street, Chengdu city”, the determined geographical area may be “Chengdu” correspondingly.

In one embodiment, if the client device 3 used by the user includes a positioning device, such as a global positioning system (GPS), the location module 102 may acquire the location of the user via the positioning device through the network 2. For example, the location module 102 may send a message to the client device 3 to notify the user activating the positioning device, and then acquires the location of the user from the positioning device after the positioning device is activated. In other embodiments, if the client device 3 does not include the positioning device, the location module 102 may acquire the location of the user by notifying the user to input his/her location using the client device 3.

The display module 103 searches for products local to the determined geographical area (hereinafter, “local products”) from the product database 111, and displays the searched local products on a user interface for the user to select his/her favorite. In one embodiment, the user interface may be displayed in a form of a webpage through a display device of the client device 3.

The address searching module 104 searches purchasing addresses of a selected local product from the product database 111, and determines the nearest purchasing address of the selected local product. In the embodiment, the nearest purchasing address has a minimum distance to the location of the user.

The route calculation module 105 calculates one or more routes from the location of the user to the nearest purchasing address according to the electronic map 110, and displays the calculated one or more routes to the user through the user interface. The one or more routes may include at least one bus route and/or at least one driving route. In an alternative embodiment, the route calculation module 105 further calculates all of routes from the location of the user to each of the searched purchasing addresses, and displays each of the calculated routes to the user through the user interface.

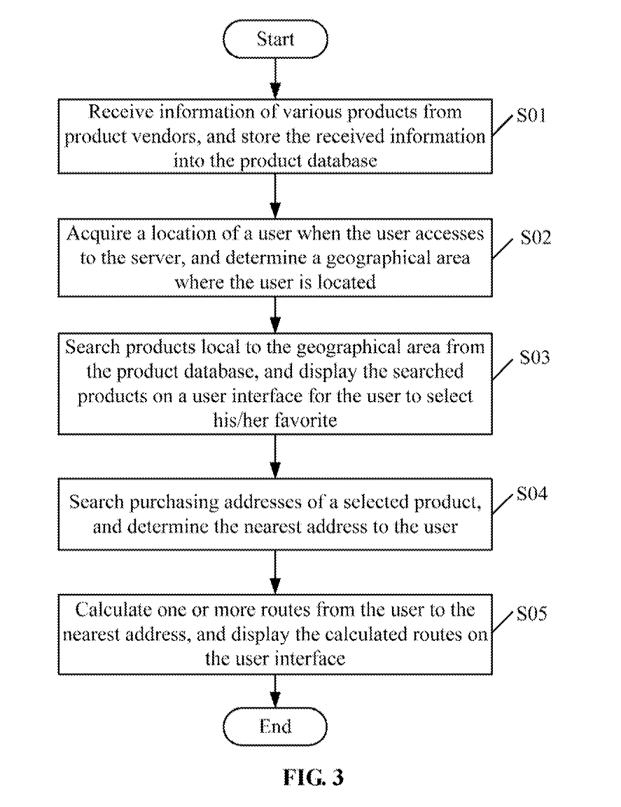

FIG. 3 is a flowchart of one embodiment of a method for providing information of local products using the server 1 of FIG. 1. Depending on the embodiment, additional steps may be added, others removed, and the ordering of the steps may be changed.

In step S01, the receiving module 101 receives information of various products from one or more product vendors, and stores the received information into the product database 111. The received information includes, for example, names, prices and images of the products, and purchasing addresses of the products.

In step S02, when the user accesses the server 1 using the client device 3, the location module 102 acquires a location of the user, and determines a geographical area where the user is located according to the location of the user.

In step S03, the display module 103 searches for products local to the determined geographical area (local products) from the product database 111, and displays the searched local products on a user interface for the user to select his/her favorite.

In step S04, when a searched local product is selected by the user, the address searching module 104 searches purchasing addresses of the selected local product from the product database 111, and determines the nearest purchasing address to the user.

In step S05, the route calculation module 105 calculates one or more routes from the location of the user to the nearest purchasing address according to the electronic map 110, and displays the calculated one or more routes to the user through the user interface. The one or more routes may include at least one bus route and/or at least one driving route. Alternatively, the route calculation module 105 may further calculate all of routes from the location of the user to each of the searched purchasing addresses, and displays each of the calculated routes to the user through the user interface.

Although certain embodiments of the present disclosure have been specifically described, the present disclosure is not to be construed as being limited thereto. Various changes or modifications may be made to the present disclosure without departing from the scope and spirit of the present disclosure.

1. A computerized method for providing information of local products using a server, the server comprising an electronic map and a product database, the method being performed by execution of a computer-readable program instructions by at least one processor of the server, the method comprising:
receiving information of various products from one or more product vendors, and storing the received information into the product database;
acquiring a location of a user when the user accesses the server through a network using a client device having a positioning device, and determining a geographical area where the user is located according to the location of the user, wherein the location of the user is acquired by sending a message to the client device to activate the positioning device and acquiring the location of the user from the positioning device through the network after the positioning device has been activated;
searching for products local to the determined geographical area from the product database, and displaying the searched products on a user interface for the user to select his/her favorite;
in response to one of the searched products is being selected, searching purchasing addresses of the selected product from the product database, and determining the nearest purchasing address to the user; and
calculating one or more routes from the location of the user to the nearest purchasing address according to the electronic map, and displaying the calculated one or more routes on the user interface.

2. The method according to claim 1, wherein the received information comprises names, prices and images of the products, and purchasing addresses of the products.

3. The method according to claim 1, wherein the calculating step further comprises:
calculating all of routes from the location of the user to each of the searched purchasing addresses, and displaying each of the calculated routes on the user interface.

4. The method according to claim 1, wherein the receiving step further comprises:
sending an advertisement message relevant to the products to the client devices through a network, the advertisement message comprising popular products in the product database and a way to access the server.

5-6. (canceled)

7. A server, comprising:
a storage system comprising an electronic map and a product database;
at least one processor; and
one or more programs stored in the storage system and executed by the at least one processor, the one or more programs comprising:
a receiving module that receives information of various products from one or more product vendors, and stores the received information into the product database;
a location module that acquires a location of a user when the user accesses the server through a network using a client device having a positioning device, and determines a geographical area where the user is located according to the location of the user, wherein the location module acquires the location of the user by sending a message to the client device to activate the positioning device, and then acquires the location of the user from the positioning device through the network after the positioning device has been activated;
a display module that searches for products local to the determined geographical area from the product database, and displays the searched products on a user interface for the user to select his/her favorite;
an address searching module that searches purchasing addresses of a selected product from the product database, and determines the nearest purchasing address to the user; and
a route calculation module that calculates one or more routes from the user to the nearest purchasing address according to the electronic map, and displaying displays the calculated one or more routes on the user interface.

8. The server according to claim 7, wherein the received information comprises names, prices and images of the products, and purchasing addresses of the products.

9. The server according to claim 7, wherein the route calculation module further calculates all of routes from the user to each of the searched purchasing addresses, and displays each of the calculated routes on the user interface.

10. The server according to claim 7, wherein the receiving module further sends an advertisement message relevant to the products to the client devices through a network, the advertisement message comprising popular products in the product database and a way to access the server.

11-12. (canceled)
